(19) United States
(12) Patent Application Publication
(10) Pub. No.: US 2026/0257704 A1
(43) Pub. Date: Sep. 3, 2026

(54) CROWDSENSING-BASED METHOD FOR GENERATING TEMPORARY SPEED RESTRICTION OF TRAIN

(71) Applicant: CASCO SIGNAL LTD., Shanghai (CN)

(72) Inventors: Lei FENG, Shanghai (CN); Fanyu Ceng, Shanghai (CN); Hongjun JIANG, Shanghai (CN); Xiaodan CUI, Shanghai (CN); Yaohua CHEN, Shanghai (CN); Cheng ZHANG, Shanghai (CN); Jiao CHEN, Shanghai (CN); Xiaowei HOU, Shanghai (CN)

(73) Assignee: CASCO SIGNAL LTD., Shanghai (CN)

(21) Appl. No.: 19/657,060

(22) Filed: Apr. 24, 2026

Related U.S. Application Data
(63) Continuation-in-part of application No. PCT/CN2024/131288, filed on Nov. 11, 2024.

(30) Foreign Application Priority Data
Sep. 9, 2024 (CN) 202411255925.0

(51) Int. Cl. B61L 15/00; B61L 23/04; G06N 7/01

(52) U.S. Cl. CPC B61L 15/0062; B61L 15/0027; B61L 23/042; G06N 7/01

(57) ABSTRACT

A crowdsensing-based method for generating a temporary speed restriction of a train includes: detecting a running track environment based on a crowdsensing technology, and intelligently fusing multi-sensing-source sensing results by means of an intelligent fusion unit for multi-sensing-source sensing results for performing comprehensive judgment and outputting a speed restriction request, where the speed restriction request includes a requested speed restriction zone and a requested speed restriction value; generating, by the temporary speed restriction server, a temporary speed restriction command based on the received speed restriction request, and sending the temporary speed restriction command to train control center equipment or the radio block center equipment, a jurisdiction scope of which covers the requested speed restriction zone; and automatically issuing, by the train control center equipment or the radio block center equipment, the temporary speed restriction command to a train entering the speed restriction zone.

### CROSS REFERENCE TO THE RELATED APPLICATIONS

This application is the continuation-in-part application of International Application No. PCT/CN2024/131288, filed on Nov. 11, 2024, which is based upon and claims priority to Chinese Patent Application No. 202411255925.0, filed on Sep. 9, 2024, the entire contents of which are incorporated herein by reference.

### TECHNICAL FIELD

The present disclosure relates to the technical field of rail transit, and in particular, to a crowdsensing-based method for generating a temporary speed restriction of a train, an electronic device, and a storage medium.

### BACKGROUND

Temporary speed restriction of trains serves as a key measure to address sudden line abnormalities and ensure the safety of train operation. The timeliness and accuracy of its generation directly bear on the safety and operational efficiency of railway transport. However, at present, the generation of temporary speed restriction is primarily realized through trackside fixed monitoring devices and manual input. Such approaches are associated with disadvantages including high deployment cost, blind monitoring coverage, relatively long response latency, incapability of achieving rapid extended coverage over abnormal regions, as well as frequent misjudgment or delayed management and control, thereby failing to satisfy the demands for intelligent and refined safe operation of railways. This patent deeply exploits the autonomous sensing results of vehicles, diffuses the sensing results of a single vehicle by fully utilizing crowdsensing technology, thereby improving the system safety.

Therefore, it is necessary to propose a crowdsensing-based method for generating a temporary speed restriction of a train, an electronic device, and a storage medium, so as to solve the problem of relying on manual issuance of temporary speed restriction commands in the prior art.

### SUMMARY

An objective of the present disclosure is to provide a crowdsensing-based method for generating a temporary speed restriction of a train, an electronic device, and a storage medium, so as to solve the problem of relying on manual issuance of temporary speed restriction commands in the prior art.

To achieve the above objective, the present disclosure provides a crowdsensing-based method for generating a temporary speed restriction of a train, including:
detecting a running track environment based on a crowdsensing technology, and intelligently fusing multi-sensing-source sensing results including trains, drivers or scheduling personnel, unmanned aerial vehicles and satellite remote sensing by means of an intelligent fusion unit for multi-sensing-source sensing results, where the intelligent fusion unit adopts a temporal-spatial two-stage boosting fusion architecture: the first stage employs LightGBM to perform temporal residual fitting on vehicle-end slip data and outputs a microscopic risk index, and the second stage adopts AdaBoost to perform weighted fusion on the microscopic risk index and the multi-sensing-source sensing results, after fusion, performing a comprehensive judgment and outputting a speed restriction request, where the speed restriction request includes a requested speed restriction value, a requested speed restriction area, a speed restriction object vehicle type, and a speed restriction time range; and the intelligent fusion unit for multi-sensing-source sensing results is composed of a plurality of differentiated independent computing units, which respectively generate fusion results by adopting differentiated fusion algorithms, and then integrates the fusion results of each independent computing unit. If any independent computing unit determines that a speed restriction request needs to be generated, the unit as a whole shall determine to generate a speed restriction request;
generating, by the temporary speed restriction server, a temporary speed restriction command based on the received speed restriction request, and sending the temporary speed restriction command to train control center equipment or the radio block center equipment, a jurisdiction scope of which covers the requested speed restriction zone, where the temporary speed restriction command comprises a speed restriction zone and a speed restriction value; and
automatically issuing, by the train control center equipment or the radio block center equipment, the temporary speed restriction command to a train entering the speed restriction zone.

Preferably, the step of performing temporal residual fitting on vehicle-end slip data by means of LightGBM and outputting a microscopic risk index includes:
constructing a feature vector x=[Sₜ,Nₕᵢₛₜ], where Sₜ is a real-time slip severity of the current train, with a value range of 0-1; Nₕᵢₛₜ is the number of historically continuous slipping trains at this position;
dividing a feature space into a plurality of non-overlapping leaf node regions, each of which corresponds to a physical risk pattern;
determining whether current data falls within a corresponding risk pattern by means of a discriminant function, and iteratively updating the risk prediction value according to the trained leaf node weights; and
outputting a microscopic risk index at the train end.

Preferably, the step of performing weighted fusion on the microscopic risk index and the multi-sensing-source sensing results by means of AdaBoost includes:
constructing a fused feature vector X_{fusion}[Rₜᵣₐᵢₙ, Pᵤₐᵥ, Iₛₐₜ, V_{geo}], where Rₜᵣₐᵢₙ is a microscopic risk index output by the first-stage architecture; Pᵤₐᵥ is a probability of foreign objects or falling rocks identified by an unmanned aerial vehicle; Iₛₐₜ is a satellite-retrieved rainfall intensity/spectral anomaly; V_{geo} is a static geographic feature in this section, at least including a gradient and a curve radius;
using a plurality of independent weak classifiers to respectively correspond to different sensors and outputting a dangerous or safe determination result; and
dynamically updating the trust weight of each sensor according to historical data thereof, and obtaining a comprehensive risk score through weighted summation based on the trust weight of each sensor.

Preferably, the step of performing a comprehensive judgment and outputting a speed limit request includes:
converting a comprehensive risk score into a speed restriction value through nonlinear regression mapping, and outputting a speed restriction request after temporal smoothing.

Preferably, converting the comprehensive risk score into a speed restriction value via nonlinear regression mapping includes:
mapping the comprehensive risk score to a comprehensive hazard degree Dₜₒₜₐₗ ranging from 0 to 1 by means of a Sigmoid function, and calculating the speed restriction value Vₗᵢₘᵢₜ based on the following formula:

Vₗᵢₘᵢₜ=Vₘₐₓ(1−Dₜₒₜₐₗ)^{λp}

where Vₘₐₓ is maximum designed speed of the line; and λp is a safety penalty factor, with a value range of 0.8-0.95.

Preferably, the step of detecting a running track environment based on a crowdsensing technology includes:
performing, by the train, track wet-skid detection, and when idling and slipping of train wheels are detected, sending the speed restriction request to the temporary speed restriction server via a wireless network.

Preferably, the step of track wet-skid detection includes:
collecting a track gradient, a train speed and slipping acceleration data;
calculating a wheel derailment probability using a Bayesian network, and calculating a train slip risk index in combination with a gradient coefficient and a speed coefficient.

Preferably, the step of generating, by the temporary speed restriction server, a temporary speed restriction command based on the received speed restriction request includes:
detecting, by the temporary speed restriction server, whether a corresponding speed restriction command exists internally according to the speed restriction request, where if the corresponding speed restriction command exists, the temporary speed restriction server checks:
whether the speed restriction zone corresponding to the existing speed restriction command covers the requested speed restriction zone;
whether the speed restriction value corresponding to the existing speed restriction command is lower than the requested speed restriction value; and
if the above conditions are not met, the temporary speed restriction command is generated.

Preferably, the step of acquiring the requested speed restriction zone includes: based on a formula:

safe distance-gradient*gradient weighting coefficient+running speed*peed weighting coefficient+crowdsensing*crowdsensing result coefficient+basic correction value of train,
calculating the safe distance, where the gradient of an uphill section is assigned a negative value, and the gradient of a downhill section is assigned a positive value; and
acquiring the requested speed restriction zone, where a scope of the requested speed restriction zone ranges from a position at a safe distance ahead of a wheel-slipping point reported by the train to a position at a safe distance behind the wheel-slipping point reported by the train.

Preferably, the step of detecting a running track environment based on a crowdsensing technology includes:
triggering, by a dispatching system, an unmanned aerial vehicle at regular time intervals; performing, by the unmanned aerial vehicle, line inspection, shooting a line running route; comparing the line running route with a route locally stored by the unmanned aerial vehicle; when it is detected that the line running route is inconsistent with the route locally stored by the unmanned aerial vehicle, sending an application to the dispatching system to apply for acquiring temporary speed restriction command information of a zone where the routes are inconsistent; if no temporary speed restriction command exists, sending alarm information to the dispatching system; and sending, by the dispatching system, the speed restriction request to the temporary speed restriction server based on the alarm information.

Preferably, the step of detecting a running track environment based on a crowdsensing technology includes:
sending, by the following train, applications periodically to the preceding train based on train-to-train communication to apply for acquiring the current position information and ambient image information of the preceding train, and sending, by the preceding train, the current position information and ambient image information to the following train; and
enabling the following train to continue to move forward, comparing the position of the following train with the position and ambient image of the preceding train after the following train arrives at the position of the preceding train or finds the position corresponding to the ambient image sent by the preceding train, and for a determined position, when it is found that the ambient image does not match the position, or for a determined ambient image, it is found that the position does not match the position of the preceding train, sending a “multi-train mutual verification error” to the temporary speed restriction server.

Preferably, the step of generating, by the temporary speed restriction server, a temporary speed restriction command based on the received speed restriction request includes:
upon receiving the “multi-train mutual verification error” information sent by more than N trains, generating, by the temporary speed restriction server, the temporary speed restriction command, wherein the speed restriction value of the temporary speed restriction command is the minimum permissible speed for the corresponding route, and the speed restriction zone is the maximum scope of reporting areas for different trains.

Preferably, the step of detecting a running track environment based on a crowdsensing technology includes:
observing, by a train driver, an ambient environment based on self-recognition, and when the train driver finds that the ambient environment is severe, entering the speed restriction request by an operation interface of an automatic train protection system or an automatic train operation system, and reporting the speed restriction request to the temporary speed restriction server by the automatic train protection system or the automatic train operation system.

Preferably, the step of detecting a running track environment based on a crowdsensing technology includes:
based on satellite remote sensing, performing remote sensing photographing for the route by a software-defined radio satellite with a low revisit cycle, receiving, analyzing, and processing, by a remote sensing image receiver, an image to acquire a disaster situation analysis result, and sending the speed restriction request to the temporary speed restriction server based on the disaster situation analysis result.

Preferably, the method further includes:
when the speed restriction zone is manually confirmed to no longer require speed restriction, manually canceling the temporary speed restriction command.

Preferably, the method further includes:
issuing, by the temporary speed restriction server, a “temporary speed restriction canceling” test task, and upon receiving the test task, determining, by the train, whether a detection condition is met, wherein if the detection condition is met, an unmanned single locomotive passes through the speed restriction zone in excess of the speed restriction and feeds back a detection result of the running track environment to the temporary speed restriction server, and a passenger and cargo-carrying train strictly complies with the speed restriction when passing through the speed restriction zone and feeds back the detection result; and
upon receiving, by the temporary speed restriction server, consecutive N safety responses, feeding back a result in combination with the trains, wherein if the result exceeds a safety threshold, the temporary speed restriction command is canceled.

Preferably, the step of determining whether a detection condition is met includes:
determining whether other trains and danger points exist within a set distance ahead of the train, where if not, the detection condition is met.

The present disclosure further provides an electronic device, including a processor and a memory, where the memory stores a computer program, and the computer program, when executed by the processor, implements any one crowdsensing-based method for generating a temporary speed restriction of a train.

The present disclosure further provides a readable storage medium, storing a computer program, where the computer program, when executed by a processor, implements any one crowdsensing-based method for generating a temporary speed restriction of a train.

Compared with the prior art, the technical solutions of the present disclosure have the following beneficial effects:

The crowdsensing-based method for generating a temporary speed restriction of a train provided by the present disclosure detects the train running track environment by the crowdsensing technology and performs intelligent fusion and comprehensive judgment on the multi-source sensing data by means of the intelligent fusion unit for multi-sensing-source sensing results to automatically output the speed restriction request including the requested speed restriction value, the request speed restriction area, the speed restriction object vehicle type, and the speed restriction time range, so as to achieve differential fusion and reliable judgment of the multi-sensing-source information. Any independent calculation unit judges speed restriction to integrally trigger speed restriction. Through multi-channel independent fusion and an error-driven weight adjustment mechanism, the system false alarm rate is reduced by 90%, the output volatility is reduced by 96%, and the impact of erroneous speed limiting on operational efficiency is avoided, thereby improving the real-time performance, accuracy and safety of temporary speed restriction; by constructing an integrated crowdsensing network, the blind spot coverage rate is increased by 40%, eliminating the need for additional deployment of a large number of trackside monitoring devices, thereby reducing the usage quantity and operational frequency of a track inspection vehicle.

According to the crowdsensing-based method for generating a temporary speed restriction of a train provided by the present disclosure, the train may achieve self-inspection based on self-information or train-to-train communication. The train itself is not only a train that completes a transmission task, but also a running track environment detection train, without adding an extra environment detection system but reusing the measurement data such as speed measurement data and distance measurement data required for train control by the existing automatic train protection system or automatic train operation system. The train may discover problems in a timely manner without waiting for specific train detection, such that the detection period in a severe environment may be shortened, and the period of manual confirmation and entry is shortened. Compared with existing modes of manually issuing speed restriction, the present disclosure can reduce the emergency response time from the minute level (3-10 minutes) to the millisecond level (1 second), improving the response speed by three orders of magnitude. To improve the reliability, a multi-round collection approach is adopted, and decision-making can still be completed within 10 seconds, gaining precious golden time for emergency braking of trains under sudden disasters, thereby effectively avoiding derailment or collision accidents caused by instruction delay.

The crowdsensing-based method for generating a temporary speed restriction of a train provided by the present disclosure supports vehicle-to-vehicle communication and disseminates hazard information. When the preceding train detects severe track slippage with a slip degree exceeding a threshold, it can directly disseminate temporary speed restriction information to subsequent trains. The conventional train-trackside-train transmission link is shortened and a direct train-to-train link is realized. Two delays caused by train-trackside transmission are saved. Considering the network delay and retransmission, up to 30 seconds can be saved. For a train traveling at 160 km/h, the danger ahead can be detected 1,300 meters earlier compared with conventional methods. The method automatically detect and propagate the problems, so as to avoid human failures caused by manual problem discovery and system entry by operation personnel. Moreover, this solution achieves automatic integration of multi-source information, further improving the safety of the system.

### BRIEF DESCRIPTION OF THE DRAWINGS

FIG. 1 is a flow schematic diagram of a crowdsensing-based method for generating a temporary speed restriction of a train in an embodiment of the present disclosure.

FIG. 2 is a schematic diagram of a working principle of a crowdsensing-based method for generating a temporary speed restriction of a train in an embodiment of the present disclosure.

FIG. 3 is a flow schematic diagram of a crowdsensing-based method for generating a temporary speed restriction of a train in an embodiment of the present disclosure.

FIG. 4 is a schematic diagram of a work of canceling a temporary speed restriction test task in a crowdsensing-based method for generating a temporary speed restriction of a train in an embodiment of the present disclosure.

### DETAILED DESCRIPTION OF THE EMBODIMENTS

A crowdsensing-based method for generating a temporary speed restriction of a train, an electronic device, and a storage medium provided by the present disclosure will be further described in detail below in conjunction with drawings and specific embodiments. Based on the following description, the advantages and features of the present disclosure will be made clearer. It should be noted that the drawings are presented in a highly simplified form and do not conform to precise proportions, which are only intended to conveniently and clearly illustrate the implementation modes of the present disclosure. To make the objectives, features and advantages of the present disclosure more apparent and comprehensible, reference is made to the drawings. It should be understood that the structures, proportions, dimensions, and the like depicted in the drawings attached to this specification are merely intended to cooperate with the contents disclosed in the specification, for the understanding and perusal of those skilled in the art, and are not intended to limit the implementation conditions of the present disclosure. Therefore, they have no substantial technical significance. Any modification of structures, change of proportional relationships or adjustment of dimensions shall still fall within the scope covered by the technical contents disclosed in the present disclosure, provided that such modifications do not affect the efficacy and intended objectives achievable by the present disclosure.

It should be noted that, in this specification, relational terms such as “first” and “second” are used merely to distinguish one entity or operation from another entity or operation, and do not necessarily require or imply that any such actual relationship or sequence exists between these entities or operations. Furthermore, the terms “comprising”, “including” or any other variants thereof are intended to cover a non-exclusive inclusion, such that a process, method, article or apparatus that comprises a series of elements includes not only those elements but also other elements not expressly listed, or elements inherent in such process, method, article or apparatus. Without further limitations, an element defined by the phrase “comprising one . . . ” does not exclude the presence of additional identical elements in the process, method, article, or apparatus that includes the element.

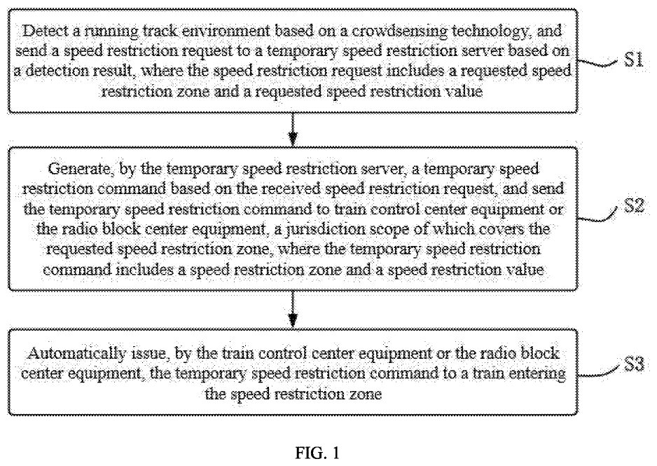

Referring to FIG. 1, FIG. 1 is a flow schematic diagram of a crowdsensing-based method for generating a temporary speed restriction of a train in an embodiment of the present disclosure. The method includes the following steps:

Step S1: a running track environment is detected based on a crowdsensing technology, and multi-sensing-source sensing results including trains, drivers or scheduling personnel, unmanned aerial vehicles and satellite remote sensing are intelligently fused by means of an intelligent fusion unit for multi-sensing-source sensing results, where the intelligent fusion unit adopts a temporal-spatial two-stage boosting fusion architecture: the first stage employs LightGBM to perform temporal residual fitting on vehicle-end slip data and outputs a microscopic risk index, and the second stage adopts AdaBoost to perform weighted fusion on the microscopic risk index and the multi-sensing-source sensing results, after fusion, a comprehensive judgment is performed and a speed restriction request is output, where the speed restriction request includes a requested speed restriction value, a requested speed restriction area, a speed restriction object vehicle type, and a speed restriction time range; and the intelligent fusion unit for multi-sensing-source sensing results is composed of a plurality of differentiated independent computing units, which respectively generate fusion results by adopting differentiated fusion algorithms, and then integrates the fusion results of each independent computing unit. If any independent computing unit determines that a speed restriction request needs to be generated, the unit as a whole shall determine to generate a speed restriction request;

in Step S1, the crowdsensing technology may include multi-source information such as the train itself, a train driver, an unmanned aerial vehicle, and satellite remote sensing, and improves the safety of the system by automatically fusing the multi-source information. Each sensing entity may transmit data to a temporary speed restriction server (TSRS) via a secure communication protocol. The secure communication protocol shall include timeliness, sequence and integrity; for wireless networks, the information security of data shall also be protected through encryption keys.

Step S2: the temporary speed restriction server (TSRS) generates a temporary speed restriction command based on the received speed restriction request, and sends the temporary speed restriction command to train control center (TCC) equipment or radio block center (RBC) equipment, a jurisdiction of which covers the requested speed restriction zone, where the temporary speed restriction command includes a speed restriction zone and a speed restriction value; and

Step S3: the train control center equipment or the radio block center equipment automatically issues the temporary speed restriction command to a train entering the speed restriction zone.

According to the crowdsensing-based method for generating a temporary speed restriction of a train provided by the present disclosure, the train may discover problems in a timely manner without waiting for specific train detection, such that the detection period in a severe environment may be shortened, and the period of manual confirmation and entry is shortened. The temporary speed restriction in the prior art is generated by a dispatcher through a dispatching system (centralized traffic control (CTC)), issued to the trackside train control equipment and then transmitted to the onboard train control equipment of the train. The technical solution in this embodiment detects the train running track based on the crowdsensing technology, and performs intelligent fusion and comprehensive judgment on the multi-source sensing data by means of the intelligent fusion unit for multi-sensing-source sensing results to automatically output the speed restriction request including the requested speed restriction value, the request speed restriction area, the speed restriction object vehicle type, and the speed restriction time range, so as to achieve differential fusion and reliable judgment of the multi-sensing-source information. Any independent calculation unit judges speed restriction to integrally trigger speed restriction, thereby improving the real-time performance, accuracy and safety of temporary speed restriction. The temporary speed restriction server generates and issues the temporary speed restriction command based on the speed restriction request, and generates the temporary speed restriction command from the origin without manually issuing the temporary speed restriction command, thereby improving the safety of the system.

The algorithm architecture and the execution flow of the intelligent fusion unit in this embodiment will be further described below.

In the first-stage architecture of the intelligent fusion unit, first, feature vectorization processing is performed on the train end sensing data.

In some embodiments, a feature vector x=[Sₜ,Nₕᵢₛₜ] may be constructed, where Sₜ is a real-time slip severity of the current train, with a value range of 0-1; Nₕᵢₛₜ is the number of historically continuous slipping trains at this position.

Further, a feature space may be divided into J non-overlapping leaf node regions {R₁ₘ,R₂ₘ, . . . ,Rⱼₘ} through the m^{th} regression tree, each of which corresponds to a physical risk pattern; for example, a corresponding rule for a certain special region Rₖₘ is: Sₜ>0.6 and Nₕᵢₛₜ≥2 (severe current slipping and continuous train slipping).

Whether the current train data falls into the corresponding risk pattern may be determined by an indicator function I(x∈Rⱼₘ). If yes, 1 is output, and otherwise 0 is output. Each leaf node Rⱼₘ corresponds to one weight value γⱼₘ. This value may be obtained by minimizing the mean square error loss function, and a weight of high-risk areas is a positive value, which is preferably 0.5.

A calculation formula for iteratively updating the risk prediction value Fm(x) is as follows:

Fₘ(x)=Fₘ₋₁(x)+η·γⱼₘ, where n is a learning rate, preferably 0.01-0.1, configured to balance a convergence speed and an overfitting risk. After multiple iterations, an output value of Fm(x) is the microscopic risk index Rₜᵣₐᵢₙ of the train end, with a value range of 0-1.

In the second-stage architecture of the intelligent fusion unit, sensing results with different physical dimensions may be uniformly mapped into a fused feature vector X_{fusion} via AdaBoost.

In some embodiments, X_{fusion} [Rₜᵣₐᵢₙ, Pᵤₐᵥ,Iₛₐₜ, V_{geo}], where Rₜᵣₐᵢₙ is a microscopic risk index output by the first-stage architecture; Pᵤₐᵥ is a probability of foreign objects or falling rocks identified by an unmanned aerial vehicle, with a value range of 0-1; Iₛₐₜ is a satellite-retrieved rainfall intensity/spectral anomaly and the unit is mm/h; V_{geo} is a static geographic feature in this section, at least including a gradient and a curve radius, as a static context.

In the above embodiments, further, multiple types of sensors may be fused using weak classifiers.

$$H ( x ) = sign ( {\sum }_{k = 1}^{K} {α}_{k} \cdot {h}_{k} ( {X}_{fusion} ) ) ,$$

where hₖ(X_{fusion}) is a weak estimator output. In some embodiments, three independent weak estimator outputs may be used to correspond to three types of sensors, respectively: h₁(X_{fusion}) is a train-end sensor judgment logic; when Rₜᵣₐᵢₙ>0.7, +1 (dangerous) is output, and otherwise −1 (safe) is output; h₂(X_{fusion}) is an UAV sensor judgment logic; when Pᵤₐᵥ>0.8, +1 is output, and otherwise −1 is output; h₃(X_{fusion}) is a satellite sensor judgment logic; when Iₛₐₜ>50 mm/h, +1 is output, and otherwise −1 (safe) is output. αₖ is a weight coefficient, which may be automatically calculated by an algorithm according to historical data. For example, under heavy rain conditions, the accuracy of satellite data Iₛₐₜ is higher than that of UAV Pᵤₐᵥ. Therefore, h₃(X_{fusion}) has a greater weight coefficient α₃.

In some embodiments, to ensure the adaptability of the algorithm, an error rate e may be introduced to dynamically adjust the weights. In the m^{th} iteration, a calculation formula for a classification error rate ϵ_{k,m} of the kth sensor channel is as follows:

$${ϵ}_{k , m} = P ( {h}_{k} ( {X}_{fusion} ) \neq {y}_{true} ) ,$$

where yₜᵣᵤₑ is a historically true safety/accident label.

In the above embodiments, based on the following formula, the weight coefficient α_{k,m} of the corresponding sensor may be updated according to the error rate ϵ_{k, m}:

$${α}_{k , m} = \frac{1}{2} ln ( \frac{1 - {ϵ}_{k , m}}{{ϵ}_{k , m}} )$$

In the above embodiments, based on the calculation formula of the weight coefficient, if a sensor (such as a UAV) frequently generates false alarms in the current scenario (with an increased error rate ϵ_{k,m}), the corresponding weight coefficient α_{k,m} will decrease. Therefore, the function of automatically shielding unreliable sensors can be mathematically implemented without manual intervention.

In the above embodiments, a calculation formula of a final comprehensive risk score Score is as follows:

Score=Σαₖhₖ(X_{fusion})

Based on the calculated Score, the score may be mapped to a comprehensive hazard degree Dₜₒₜₐₗ between 0 and 1 through a Sigmoid function and is ultimately converted into a speed restriction value Vₗᵢₘᵢₜ. A calculation formula of the Vₗᵢₘᵢₜ is as follows:

Vₗᵢₘᵢₜ=Vₘₐₓ (1−Dₜₒₜₐₗ)^{λp}, where Vₘₐₓ is the maximum designed speed of the line, which is determined in accordance with actual line standards; λp is a value-adjustable safety penalty factor, preferably 0.8-0.95; the larger the value of λp, the severer the risk penalty. When the Boosting fusion model determines that the risk is extremely high (Dₜₒₜₐₗ approaches 1), (1−Dₜₒₜₐₗ) approaches 0, and the speed restriction value Vₗᵢₘᵢₜ decreases to 0 rapidly. When the multi-source data shows the safety (Dₜₒₜₐₗ approaches 0), the speed restriction value Vₗᵢₘᵢₜ is maintained at Vₘₐₓ.

In the above embodiments, to balance the response speed and the command stability, Vₗᵢₘᵢₜ and Vₘₐₓ data at N time points may be continuously collected by the temporary speed restriction server for weighted smoothing, so as to comprehensively judge and obtain a speed restriction which shall be output at the current time:

$${V}_{out}^{( t )} = min ( {V}_{max}^{( i )} , \frac{{\sum }_{i = 0}^{N - 1} {λ}^{i} \cdot {V}_{limit}^{( t - i )}}{{\sum }_{i = 0}^{N - 1} {λ}^{i}} ) ,$$

where i represents a historical step size relative to the current time t, i=0 is the current time, and i=N−1 is the earliest time of the window. N is a length of the time window, preferably 25 (corresponding to 1 second, with a sampling rate of 25 Hz). λ is a time decay factor 0<λ≤1. The closer λ is to 1, the greater the weight of historical data, the smoother the output, and the stronger the anti-interference capability. The closer λ is to 0, the more emphasis is placed on current data, resulting in faster response. Preferably, λ is within 0.8-0.95 to balance the response speed and stability.

In some embodiments, the above all calculation steps are executed by field-programmable gate array (FPGA) accelerator board of the temporary speed restriction sever, with a single-round decision latency less than 500 ms.

In some embodiments, the step of detecting a running track environment based on a crowdsensing technology includes:
the train performs track wet-skid detection for the train, and when idling and slipping of train wheels are detected, sends the speed restriction request to the temporary speed restriction server via a wireless network. In some embodiments, the speed restriction request including slippage information may also be sent to the onboard ATP/ATO equipment of the surrounding trains.

In the above embodiments, the train slip detection unit for detection may be deployed in the onboard ATP/ATO equipment to reuse data from existing speed and distance measuring sensors without extra hardware. Input parameters of the train slip detection unit include a track gradient, a real-time train speed, and a wheel slip acceleration.

In the above embodiments, based on the input parameters, the train slip detection unit may calculate a probability of derailment caused by wheel locking (derailment | current slip data) by means of the Bayesian network according to the current speed of the train and the slip acceleration of the train. A gradient coefficient V (positive for downhill and negative for uphill) according to the gradient. For example, the greater the downhill gradient, the higher the V value (as the braking distance increases exponentially). The slip risk index Rslip_{iTrain} of the train is calculated by the following formula.

Rslip_iTrain=P(derailment|current slip data)×(gradient coefficient+speed coefficient)

The speed coefficient may be determined based on the input parameters. In the above embodiments, further, the train may send the calculation result to the temporary speed restriction server on the ground via the secure communication protocol.

In the above embodiments, by constructing the integrated crowdsensing network, the blind spot coverage ratio is improved, the usage quantity and operational frequency of a track inspection vehicle is reduced, and the train may achieve self-inspection based on information of the train itself. The train itself is not only the train that completes the function, but also an environment monitoring train, without adding an extra environment monitoring system but reusing the measurement data such as speed measurement data and distance measurement data required for train control by the existing ATP/ATO.

In the above embodiments, the safety coefficient of the train is improved. The train may discover problems in a timely manner according to its own conditions without waiting for specific train detection, such that the detection period in a severe environment may be shortened, and the period of manual confirmation and entry is shortened. For multiple serious on-site accidents, the equipment or driver discovers problems. However, omissions occur when the equipment or driver interacts with the dispatching system in terms of information. Omissions further occur in subsequent dispatching operation, such that other trains cannot obtain the safety warning information. In the technical solution in this embodiment, the equipment detects automatically detects and propagates the problems, so as to avoid human failures caused by manual problem discovery and system entry by operation personnel.

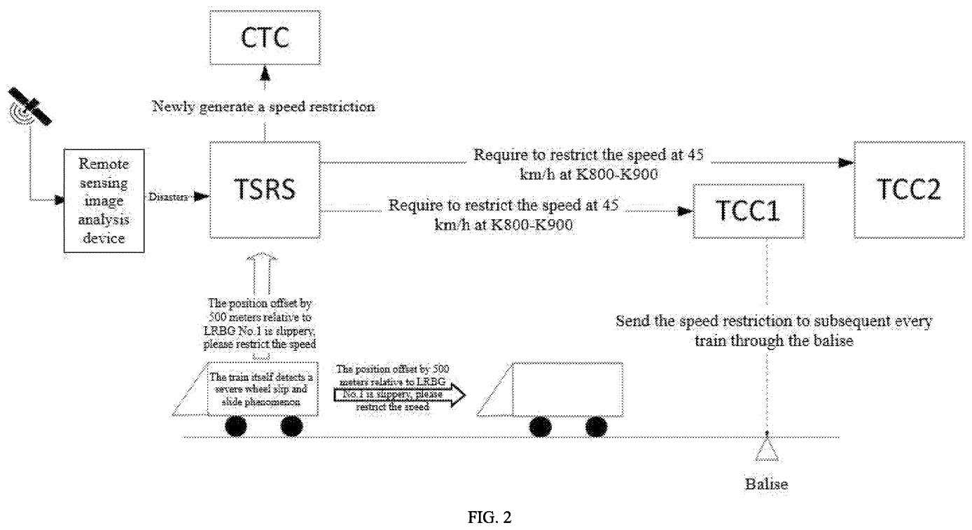

For example, referring to FIG. 2, FIG. 2 is a schematic diagram of a working principle of a crowdsensing-based method for generating a temporary speed restriction of a train in an embodiment of the present disclosure. Assuming that it snows on a certain day, however, since the snowfall is not significant, no temporary speed restriction command is issued by the dispatching system. The train itself detects idling and slipping and then brakes to stop. The driver reports this condition to the dispatching system by a dispatching telephone. The dispatching system fails to notify the following trains of the conditions ahead due to negligence (or the driver of the following train forgets that a speed restriction is in place ahead). However, by adopting the technical solution in this embodiment, the current train discovering problems sends speed restriction warning via the secure communication protocol to the following train in a timely manner, and upon receiving the speed restriction warning, the following train adopts a speed-reducing measure.

Meanwhile, this train further automatically send this information to the TSRS equipment via the secure communication protocol. The TSRS automatically generates the temporary speed restriction command according to the reported temporary speed restriction condition, and upon identifying the TCC/RBC, the jurisdictional scope of which overlaps with this area, the TSRS re-issues the speed restriction information to the relevant TCC/RBC. The current train drives through the speed restriction zone at a low speed, and the following train also travels through the speed restriction zone at a low speed according to the speed restriction warning sent by the preceding train. One day later, the speed restriction is still not canceled manually, and the TCC/RBC still maintains the temporary speed restriction. Upon receiving the temporary speed restriction information via a balise or a wireless network, each train authorized to pass through this zone decelerates speed in advance, and passes through the dangerous zone safely.

In some embodiments, the step of generating, by the temporary speed restriction server, a temporary speed restriction command based on the received speed restriction request includes:
the temporary speed restriction server detects whether a corresponding speed restriction command exists internally according to the speed restriction request, where if the corresponding speed restriction command exists, the temporary speed restriction server checks:
whether the speed restriction zone corresponding to the existing speed restriction command covers the requested speed restriction zone;
whether the speed restriction value corresponding to the existing speed restriction command is lower than the requested speed restriction value; and
if the above conditions are not met, the temporary speed restriction command is generated.

In some embodiments, the step of acquiring the requested speed restriction zone includes:
based on a formula:

safe distance=gradient*gradient weighting coefficient+running speed*speed weighting coefficient+crowdsensing*crowdsensing result coefficient+basic correction value of train, where the crowdsensing*crowdsensing result coefficient may be determined based on the output of the intelligent fusion unit.

The safe distance is calculated, where the gradient of an uphill section is assigned a negative value, and the gradient of a downhill section is assigned a positive value; and

The requested speed restriction zone is: (the slipping point reported by the train−the safe distance, the slipping point reported by the train+the safe distance).

In some embodiments, the step of detecting a running track environment based on a crowdsensing technology includes:

a dispatching system triggers an unmanned aerial vehicle at regular time intervals; the unmanned aerial vehicle performs line inspection, shoots a line running route; compares the line running route with a route locally stored by the unmanned aerial vehicle; when it is detected that the line running route is inconsistent with the route locally stored by the unmanned aerial vehicle, sends an application to the dispatching system to apply for acquiring temporary speed restriction command information of a zone where the routes are inconsistent; if no temporary speed restriction command exists, sends alarm information to the dispatching system; and the dispatching system sends the speed restriction request to the temporary speed restriction server based on the alarm information. The unmanned aerial vehicle may send the sensing results to the temporary speed restriction server via the secure communication protocol.

In some embodiments, the step of detecting a running track environment based on a crowdsensing technology includes:
sending, by the following train, applications periodically to the preceding train based on train-to-train communication to apply for acquiring the current position information and ambient image information of the preceding train, and sending, by the preceding train, the current position information and ambient image information to the following train; and
enabling the following train to continue to move forward, comparing the position of the following train with the position and ambient image of the preceding train after the following train arrives at the position of the preceding train or finds the position corresponding to the ambient image sent by the preceding train, and for a determined position, if the ambient image is found to not match the position, or for a determined ambient image, if the position is found to not match the position of the preceding train, sending a “multi-train mutual verification error” to the temporary speed restriction server.

In the above embodiments, when the temporary speed restriction is formed, information of a plurality of trains is fused, such that a plurality of train perception information is fused.

In some embodiments, the step of generating, by the temporary speed restriction server, a temporary speed restriction command based on the received speed restriction request includes:
upon receiving the “multi-train mutual verification error” information sent by more than N trains, the temporary speed restriction server generates the temporary speed restriction command, where the speed restriction value of the temporary speed restriction command is the minimum permissible speed for the corresponding route, and the speed restriction zone is the maximum scope of reporting areas for different trains.

In some embodiments, the step of detecting a running track environment based on a crowdsensing technology includes:
a train driver observes an ambient environment based on self-recognition, and when the train driver finds that the ambient environment is severe, the train driver enters the speed restriction request by an operation interface of an automatic train protection system or an automatic train operation system, and reports the speed restriction request to the temporary speed restriction server by the automatic train protection system or the automatic train operation system.

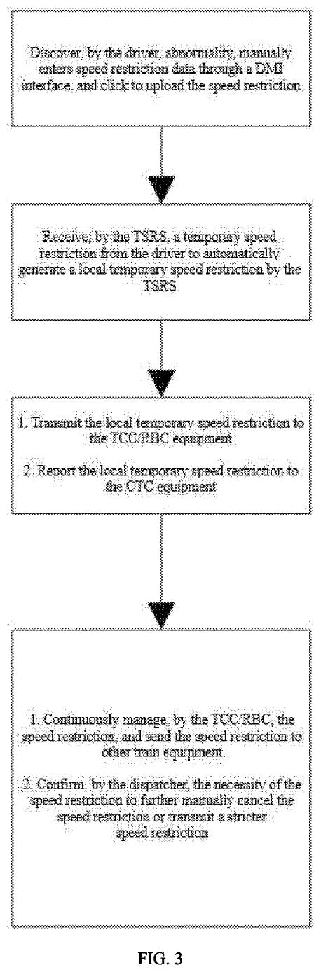

For example, referring to FIG. 3, FIG. 3 is a flow schematic diagram of a crowdsensing-based method for generating a temporary speed restriction of a train in an embodiment of the present disclosure. Assuming that in a tunnel-prone area in the western region, a certain degree of deformation has occurred to the track inside the tunnel, and after driving through the tunnel, the driver of a certain train finds that the train body is vibrating violently. While notifying the dispatcher by telephone in accordance with the existing procedures, the driver may enter temporary speed restriction data, including a speed restriction zone, a suggested speed restriction value, and speed restriction reason information through an operation interface of a desktop management interface (DMI). The ATP/ATO equipment sends this data to the TSRS equipment via the wireless network. The TSRS automatically identifies the relevant TCC/RBC according to the position reported by the driver and issues the position to the relevant TCC/RBC. The driver of this train drives out of the dangerous zone at a low speed under visual observation. Before the speed restriction is canceled, subsequently all trains passing through this zone may receive the speed restriction information from the TCC/RBC to decrease the speed in advance, and pass through this zone at a low speed.

In some embodiments, the step of detecting a running track environment based on a crowdsensing technology includes:
based on satellite remote sensing, remote sensing photographing for the route is performed by a software-defined radio satellite with a low revisit cycle, a remote sensing image receiver receives, analyzes, and processes an image to acquire a disaster situation analysis result, and sends the speed restriction request to the temporary speed restriction server based on the disaster situation analysis result.

In some embodiments, the crowdsensing-based method for generating a temporary speed restriction of a train further includes:
when the speed restriction zone is manually confirmed to no longer require speed restriction, manually canceling the temporary speed restriction command.

In other embodiments, the temporary speed restriction command may also be canceled automatically. The temporary speed restriction server issues a “temporary speed restriction canceling” test task. Upon receiving the test task, the train determines whether a detection condition is met, where if the detection condition is met, an unmanned single locomotive passes through the speed restriction zone in excess of the speed restriction and feeds back a detection result of the running track environment to the temporary speed restriction server, and a passenger and cargo-carrying train strictly complies with the speed restriction when passing through the speed restriction zone and feeds back the detection result; and
upon receiving consecutive N safety responses, by the temporary speed restriction server feeds back a result in combination with the trains, where if the result exceeds a safety threshold, the temporary speed restriction command is canceled. When the result is fed back, a credibility coefficient is increased for the result according to the own conditions of the train. The higher the speed, the higher the credibility. The greater the train load, the higher the credibility.

In some embodiments, the step of determining whether a detection condition is met includes:
whether other trains and danger points exist within a set distance ahead of the train is determined, where if not, the detection condition is met. The set distance includes: the braking distance corresponding to the maximum speed multiplied by N.

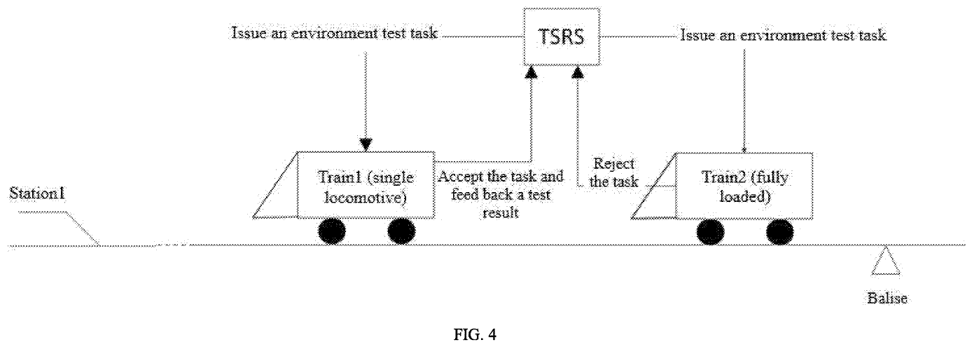

For example, referring to FIG. 4, FIG. 4 is a schematic diagram of a work of canceling a temporary speed restriction test task in a crowdsensing-based method for generating a temporary speed restriction of a train in an embodiment of the present disclosure. The temporary speed restriction server (TSRS) issues a track test task in an off-peak period at 00:00 every day (configurable). This task is to cancel the temporary speed restriction task. It is indicated in the test task that the reason for this speed restriction is weather-related. The train1 is the single locomotive. This locomotive is executing an inter-station shunting task. The driver (may be a remote control driver) confirms that the braking performance of the train is good, confirms that the distance to the forward station is relatively long and the line is straight, confirms clear weather around, and decides to accept the test task. The train drives through the speed restriction zone at an appropriate speed exceeding the speed restriction, and reports the test result that the wheels are free of slippage phenomenon. The TSRS receives the test result. Three consecutive trains accept the test task, and normal operation in the speed restriction zone is fed back. The TSRS automatically sends a canceling request to the dispatching equipment. After manually confirming that the canceling condition is met, the dispatcher clicks confirm to cancel the speed restriction, and the speed restriction command is canceled successfully.

The technical effects of the crowdsensing-based method for generating a temporary speed restriction of a train in an embodiment of the present disclosure will be further described below.

Existing single-channel technology is susceptible to environmental noise (such as sudden light changes and electromagnetic interference), resulting in false alarms. The present application adopts “multi-channel differentiated fusion”, where a risk is determined to be genuine only when a plurality of independent channels detect the risk simultaneously. According to the probability multiplication rule, the overall false alarm rate of the system is the product of the false alarm rates of individual channels. The average false alarm rate of a single channel (such as vision or radar) in a complex environment is set as P_{single}. According to the general standards for railway signal equipment, the instantaneous false alarm rate of conventional sensors is approximately 10%, that is, the value of P_{single} is about 10%.

In an embodiment of the present invention employing independent fusion of dual channels (e.g., vision channel A+radar channel B), since the noise sources of the two channels are independent of each other, the probability P_{fused} of the system generating a false alarm (i.e., simultaneous false alarms in both channels) is as follows:

$${P}_{fused} = P ( {A}_{false} ) \times P ( {B}_{false} ) = 0.1 \times 0.1 = 0.01 ,$$

A calculation formula for the reduction ratio of the false alarm rate is as follows:

$$\frac{{P}_{single} - {P}_{fused}}{{P}_{single}} = \frac{0.1 - 0.01}{0.1} = 90 \% ,$$

In summary, based on the mathematical framework, the technical solution of this embodiment achieves a theoretical reduction in false alarm rate of at least 90% compared with single-channel technology.

In the prior art, during single sampling, the output value fluctuates significantly due to random noise interference (with a large variance). In this embodiment, by introducing a continuous acquisition mechanism, the risk value is smoothed based on the law of large numbers. It is assumed that the calculated risk value for a single sampling includes a true signal and random noise, with a noise variance of σ². The present application employs a moving average algorithm with a continuous window of N=25 (assuming a sampling rate of 25 Hz, corresponding to a 1-second window). According to statistical principles, the variance σ avg² of the averaged output becomes:

$${σ}_{avg}^{2} = \frac{{σ}^{2}}{N} = \frac{{σ}^{2}}{25} ,$$

Based on the above formula, the output fluctuation is reduced by 96%, which can effectively avoid frequent jumping of speed limit commands caused by random noise.

In the prior art, a single sensor has physical blind spots (e.g., vision is limited by lighting conditions, and radar is restricted by detection angles). The fusion algorithm in this embodiment can realize blind compensation through “OR logic”. The detection probability PA of a single channel A (e.g., vehicle-mounted sensor) for a specific hazard (e.g., falling rocks from above) is set to 60%. The detection probability PB of a single channel B (e.g., environmental monitoring) for the same hazard is set to 60%. This embodiment adopts fusion judgment (an early warning is issued as long as the hazard is detected by any one channel), and the total detection probability Pₜₒₜₐₗ of the system is: 1−(1−P_{A})×(1-P_{B})=1−0.4×0.4=84%.

Based on the above calculation result, the detection probability is increased from 60% to 84%, and the blind zone coverage rate is improved by 40%.

In the conventional train speed limit issuing process, there is usually a minute-level time lag from the occurrence of a disaster (e.g., falling rocks, landslides) to the driver receiving the speed limit command. A calculation formula for a response time T_{traditional} is as follows:

$${T}_{traditional} = {t}_{detect} + {t}_{report} + {t}_{verify} + {t}_{dispatch} + {t}_{receive} ,$$

where t_{detect} is time consumed for manual detection or alarm triggering by fixed monitoring points, and manual detection or alarm from fixed monitoring points often has blind spots; tᵣₑₚₒᵣₜ is consumed for information to be reported level by level to the dispatch center; t_{verify} is time consumed for manual verification by the dispatcher (the longest step, usually 5 to 10 minutes); t dispatch is time consumed for issuing a dispatch order; and t_{receive} is time consumed for the train to receive and confirm the command.

By adopting crowdsensing and Boosting fusion algorithm of this embodiment, the response time is reduced to the millisecond level. Specifically, a calculation formula for a response time Tᵣₑₐₗₜᵢₘₑ is shown as follows:
Tᵣₑₐₗₜᵢₘₑ=tₛₑₙₛₑ+t_{compute}+t_{act}, where tₛₑₙₛₑ is a sensing delay, which is delay time of real-time collection by the train-end and unmanned aerial vehicle, and no blind spots are available in the collection process. t_{compute} is a computing delay, which is the delay time of running the Boosting fusion model at the edge side to generate a speed restriction decision, usually <500 ms. fact is an execution delay, which is the delay time for the onboard system to directly output the speed restriction curve without manual confirmation.

In summary, compared with the existing manual speed restriction issuing method, this embodiment can compress the emergency response time from the minute-level T_{traditional} to the millisecond-level Tᵣₑₐₗₜᵢₘₑ, improving the response speed by three orders of magnitude.

This embodiment further provides an electronic device, including a processor and a memory. The memory stores a computer program. The computer program, when executed by the processor, implements the crowdsensing-based method for generating a temporary speed restriction of a train in any one of the above embodiments.

This embodiment of the present disclosure further provides a readable storage medium, storing a computer program, where the computer program, when executed by a processor, implements the crowdsensing-based method for generating a temporary speed restriction of a train in any one of the above embodiments.

It should be noted that the devices and methods disclosed in the embodiments herein may also be implemented in other ways. The device embodiments described above are merely illustrative. For example, the flowcharts and block diagrams in the accompanying drawings illustrate the possible system architectures, functions, and operations of the devices, methods, and computer program products according to various embodiments herein. In this regard, each block in a flowchart or block diagram may represent a module, a segment of a program, or a portion of code, which contains one or more executable instructions for implementing the specified logical function. It should also be noted that in some alternative implementations, the functions indicated in the blocks may also occur in an order different from that indicated in the accompanying drawings. For example, two consecutive blocks may actually be executed substantially in parallel, or sometimes they may be executed in the reverse order, depending on the functions involved. It should also be noted that each block in the block diagrams and/or flowcharts, as well as combinations of blocks in the block diagrams and/or flowcharts, may be implemented by a dedicated hardware-based system for performing the specified functions or actions, or by a combination of dedicated hardware and computer instructions.

In addition, each functional module in the various embodiments herein may be integrated together to form an independent component, or each module may exist independently, or two or more modules may be integrated to form an independent component.

Although the content of the present disclosure has been described in detail through the aforementioned preferred embodiments, it should be understood that the above description shall not be deemed as a limitation of the present disclosure. After those skilled in the art reads the foregoing content, various modifications and substitutions to the present disclosure will be apparent. Therefore, the scope of protection of the present disclosure shall be defined by the appended claims.

1. A crowdsensing-based method for generating a temporary speed restriction of a train, comprising:
detecting a running track environment based on a crowdsensing technology, and intelligently fusing multi-sensing-source sensing results comprising trains, drivers or scheduling personnel, unmanned aerial vehicles and satellite remote sensing by an intelligent fusion unit for the multi-sensing-source sensing results, wherein the intelligent fusion unit adopts a temporal-spatial two-stage boosting fusion architecture: a first-stage architecture employs LightGBM to perform temporal residual fitting on vehicle-end slip data and outputs a microscopic risk index, and a second-stage architecture adopts AdaBoost to perform weighted fusion on the microscopic risk index and the multi-sensing-source sensing results, after fusion, performing a comprehensive judgment and outputting a speed restriction request, wherein the speed restriction request comprises a requested speed restriction value, a requested speed restriction area, a speed restriction object vehicle type, and a speed restriction time range; and the intelligent fusion unit for the multi-sensing-source sensing results comprises a plurality of differentiated independent computing units, which respectively generate fusion results by adopting differentiated fusion algorithms, and then integrates the fusion results of each independent computing unit; if any independent computing unit determines that the speed restriction request needs to be generated, the unit as a whole shall determine to generate the speed restriction request;
generating, by a temporary speed restriction server, a temporary speed restriction command based on a received speed restriction request, and sending the temporary speed restriction command to train control center equipment or radio block center equipment, a jurisdiction scope of which covers a requested speed restriction zone, wherein the temporary speed restriction command comprises a speed restriction zone and a speed restriction value; and
automatically issuing, by the train control center equipment or the radio block center equipment, the temporary speed restriction command to a train entering the speed restriction zone.

2. The crowdsensing-based method according to claim 1, wherein the step of performing temporal residual fitting on the vehicle-end slip data by LightGBM and outputting the microscopic risk index comprises:
constructing a feature vector x=[Sₜ,Nₕᵢₛₜ], wherein Sₜ is a real-time slip severity of a current train, with a value range of 0-1; and Nₕᵢₛₜ is a number of historically continuous slipping trains at this position;
dividing a feature space into a plurality of non-overlapping leaf node regions, wherein each of the plurality of non-overlapping leaf node regions corresponds to a physical risk pattern;
determining whether current data falls within a corresponding risk pattern by a discriminant function, and iteratively updating a risk prediction value according to trained leaf node weights; and
outputting a microscopic risk index at a train end.

3. The crowdsensing-based method according to claim 1, wherein the step of performing weighted fusion on the microscopic risk index and the multi-sensing-source sensing results by AdaBoost comprises:
constructing a fused feature vector X_{fusion} [Rₜᵣₐᵢₙ, Pᵤₐᵥ, Iₛₐₜ, V_{geo}], wherein Rₜᵣₐᵢₙ is a microscopic risk index output by the first-stage architecture; Pᵤₐᵥ is a probability of foreign objects or falling rocks identified by an unmanned aerial vehicle; Iₛₐₜ is a satellite-retrieved rainfall intensity/spectral anomaly; and V_{geo} is a static geographic feature in this section, at least comprising a gradient and a curve radius;
using a plurality of independent weak classifiers to respectively correspond to different sensors and outputting a dangerous or safe determination result; and
dynamically updating a trust weight of each sensor according to historical data thereof, and obtaining a comprehensive risk score through weighted summation based on the trust weight of each sensor.

4. The crowdsensing-based method according to claim 3, wherein the step of performing the comprehensive judgment and outputting the speed limit request comprises:
converting the comprehensive risk score into the speed restriction value through nonlinear regression mapping, and outputting the speed restriction request after temporal smoothing.

5. The crowdsensing-based method according to claim 4, wherein the step of converting the comprehensive risk score into the speed restriction value via nonlinear regression mapping comprises:
mapping the comprehensive risk score to a comprehensive hazard degree Dₜₒₜₐₗ ranging from 0 to 1 by a Sigmoid function, and calculating the speed restriction value Vₗᵢₘᵢₜ based on the following formula:
Vₗᵢₘᵢₜ=Vₘₐₓ(1−Dₜₒₜₐₗ)^{λp}
wherein Vₘₐₓ is a maximum designed speed of the line; and λp is a safety penalty factor, with a value range of 0.8-0.95.

6. The crowdsensing-based method according to claim 1, wherein the step of detecting the running track environment based on the crowdsensing technology comprises:
performing, by the train, track wet-skid detection, and when idling and slipping of train wheels are detected, sending the speed restriction request to the temporary speed restriction server via a wireless network.

7. The crowdsensing-based method according to claim 6, wherein the step of track wet-skid detection comprises:
collecting a track gradient, a train speed and slipping acceleration data; and
calculating a wheel derailment probability using a Bayesian network, and calculating a train slip risk index in combination with a gradient coefficient and a speed coefficient.

8. The crowdsensing-based method according to claim 6, wherein the step of generating, by the temporary speed restriction server, the temporary speed restriction command based on the received speed restriction request comprises:
detecting, by the temporary speed restriction server, whether a corresponding speed restriction command exists internally according to the speed restriction request, wherein
if the corresponding speed restriction command exists, the temporary speed restriction server checks:
whether the speed restriction zone corresponding to the existing speed restriction command covers the requested speed restriction zone; and
whether the speed restriction value corresponding to the existing speed restriction command is lower than the requested speed restriction value;
if the above conditions are not met, the temporary speed restriction command is generated.

9. The crowdsensing-based method according to claim 6, wherein the step of acquiring the requested speed restriction zone comprises:
based on a formula:
safe distance=gradient*gradient weighting coefficient+running speed*speed weighting coefficient+crowdsensing*crowdsensing result coefficient+basic correction value of train,
calculating the safe distance, wherein a gradient of an uphill section is assigned a negative value, and a gradient of a downhill section is assigned a positive value; and
acquiring the requested speed restriction zone, wherein a scope of the requested speed restriction zone ranges from a position at a safe distance ahead of a wheel-slipping point reported by the train to a position at a safe distance behind the wheel-slipping point reported by the train.

10. The crowdsensing-based method according to claim 1, wherein the step of detecting the running track environment based on the crowdsensing technology comprises:
triggering, by a dispatching system, an unmanned aerial vehicle at regular time intervals; performing, by the unmanned aerial vehicle, line inspection, and shooting a line running route; comparing the line running route with a route locally stored by the unmanned aerial vehicle; when it is detected that the line running route is inconsistent with the route locally stored by the unmanned aerial vehicle, sending an application to the dispatching system to apply for acquiring temporary speed restriction command information of a zone where the line running route and the route locally stored by the unmanned aerial vehicle are inconsistent; if no temporary speed restriction command exists, sending alarm information to the dispatching system; and sending, by the dispatching system, the speed restriction request to the temporary speed restriction server based on the alarm information.

11. The crowdsensing-based method according to claim 1, wherein the step of detecting the running track environment based on the crowdsensing technology comprises:
sending, by a following train, applications periodically to a preceding train based on train-to-train communication to apply for acquiring current position information and ambient image information of the preceding train, and sending, by the preceding train, the current position information and the ambient image information to the following train; and
enabling the following train to continue to move forward, comparing a position of the following train with a position and an ambient image of the preceding train after the following train arrives at the position of the preceding train or finds the position corresponding to the ambient image sent by the preceding train, and for a determined position, when it is found that the ambient image does not match the position, or for a determined ambient image, it is found that the position does not match the position of the preceding train, sending a “multi-train mutual verification error” to the temporary speed restriction server.

12. The crowdsensing-based method according to claim 11, wherein the step of generating, by the temporary speed restriction server, the temporary speed restriction command based on the received speed restriction request comprises:
upon receiving the “multi-train mutual verification error” information sent by more than N trains, generating, by the temporary speed restriction server, the temporary speed restriction command, wherein the speed restriction value of the temporary speed restriction command is a minimum permissible speed for the corresponding route, and the speed restriction zone is a maximum scope of reporting areas for different trains.

13. The crowdsensing-based method according to claim 1, wherein the step of detecting the running track environment based on the crowdsensing technology comprises:
observing, by a train driver, an ambient environment based on self-recognition, and when the train driver finds that the ambient environment is severe, entering the speed restriction request by an operation interface of an automatic train protection system or an automatic train operation system, and reporting the speed restriction request to the temporary speed restriction server by the automatic train protection system or the automatic train operation system.

14. The crowdsensing-based method according to claim 1, wherein the step of detecting the running track environment based on the crowdsensing technology comprises:
based on satellite remote sensing, performing remote sensing photographing for the route by a software-defined radio satellite with a low revisit cycle, receiving, analyzing, and processing, by a remote sensing image receiver, an image to acquire a disaster situation analysis result, and sending the speed restriction request to the temporary speed restriction server based on the disaster situation analysis result.

15. The crowdsensing-based method according to claim 1, further comprising:
when the speed restriction zone is manually confirmed to no longer require speed restriction, manually canceling the temporary speed restriction command.

16. The crowdsensing-based method according to claim 1, further comprising:
issuing, by the temporary speed restriction server, a “temporary speed restriction canceling” test task, and upon receiving the test task, determining, by the train, whether a detection condition is met, wherein if the detection condition is met, an unmanned single locomotive passes through the speed restriction zone in excess of the speed restriction and feeds back a detection result of the running track environment to the temporary speed restriction server, and a passenger and cargo-carrying train strictly complies with the speed restriction when passing through the speed restriction zone and feeds back the detection result; and
upon receiving, by the temporary speed restriction server, consecutive N safety responses, feeding back a result in combination with the trains, wherein if the result exceeds a safety threshold, the temporary speed restriction command is canceled.

17. The crowdsensing-based method according to claim 16, wherein the step of determining whether the detection condition is met comprises:
determining whether other trains and danger points exist within a set distance ahead of the train, wherein if not, the detection condition is met.

18. An electronic device, comprising a processor and a memory, wherein the memory stores a computer program, and the computer program, when executed by the processor, implements the crowdsensing-based method according to claim 1.

19. A readable storage medium, storing a computer program, wherein the computer program, when executed by a processor, implements the crowdsensing-based method according to claim 1.
